(19) United States
(12) Patent Application Publication
(10) Pub. No.: US 2008/0046355 A1
(43) Pub. Date: Feb. 21, 2008

(54) Methods and systems for matchmaking of artwork transaction

(75) Inventor: Shu-Yi Lo, Hsinchu City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/802,874

(22) Filed: May 25, 2007

(30) Foreign Application Priority Data
Aug. 15, 2006 (TW) 095129981

(51) Int. Cl. G06Q 30/00

(52) U.S. Cl. 705/37

(57) ABSTRACT

The present invention provides methods and systems for matchmaking of on-line transaction. Users could apply the platform of the present invention to make various transactions as well as correct decisions according to the remarkable effects of virtual reality. Therefore, the present invention would not only prompt the market of artwork, but also decrease the cost of transaction.

### FIELD OF INVENTION

The present invention generally relates to the field of purchasing artwork online and in particular, utilizes the 3D virtual reality to enhance the online buying experiences, more specifically, the invention relates to methods and systems for enabling on-line transaction of artwork between merchants and vendors.

### DESCRIPTION OF THE PRIOR ART

The standard quality of living advances rapidly over the last decade, thus the demand for the aesthetic artwork collection has also increased correspondingly. Traditionally, only the elite artists are able to showcase their artwork formally in a workshop and the unknown artists are ignored. However, with the advent of online discussion forum, personal website, Blog, email or etc, the new emerging artists, also known as free lance artists have began to showcase their art creations over the Internet. Surprisingly, the qualities of their works are often comparable to those elite artists. Hence recently, these new free lance artists have started to gain wider public recognition and acceptance.

At this moment, free-lance artists typically showcase their work on the Internet without any compensation. Due to the increased awareness of the copyright protection and potential business opportunities that can be obtained from licensing, free-lance artists are reluctant to exhibit their work freely and publicly on the Internet. Thus it can be a deterrent for these artists from creating any new art.

Furthermore, despite the fact that images and descriptions of the products are posted on the Internet, purchaser often depends his/her imagination in judging the tangible aspect of the item. They sometimes regret their purchase thereafter due to misrepresentation from the pictures. Besides, individuals nowadays usually buy art to decorate their houses or offices. If they solely rely on their previous experiences in deciding their purchase without actually seeing the item, it could potentially lead to customer dissatisfaction (As shown in FIG. 4).

Moreover, artworks are not available on the market as commonly as the other merchandises. The general public therefore often cannot find their preferred arts with ease unless they are abreast in the field. The lack of proper procurement channels and tools has widened the gap between the potential purchasers and the vendors. Purchasers occasionally may be unaware the existence of a great art that the vendor is trying to sell or vice versa (As shown in FIG. 5). The vendor is then discouraged by the lack of recognitions and businesses; they may eventually abandon their love of creation.

To resolve the associated problem aforementioned, a particular type of transaction platform bridges both purchasers and vendors enabling the artwork exchange with a more organized method. As a result of increased recognition of their work, these artists are now more willing to create anew, thus it raises the quality of art.

### SUMMARY OF INVENTION

In view of the aforementioned problems, methods and systems for matchmaking of artwork transaction would be provided. The present invention constitutes a platform for various users (including consumers and artists) to conduct transactions. With the virtual reality, the user could precisely determine whether the artwork and application thereof conform to her/his expectation. The methods and systems could not only prompt the market of artwork, but also decrease the cost of transaction.

One purpose of the present invention is providing a method for matchmaking of an artwork transaction. First, the user logs in the matchmaking system coupled to the digital (artwork) database. The matchmaking system includes a virtual reality module and a transaction module. After that, the user selects an artwork from the digital database as well as specific application thereof. The virtual reality module presents a virtual reality of the artwork under the application for the user to take as a reference while determining whether making a transaction. Finally, the transaction module would finish the remaining procedures according to the decision of the user.

The other purpose of the present invention is providing a matchmaking system of the artwork transaction, which comprises a processor, a virtual reality module, digital database, setting database and user database. The digital database keeps the artwork information. The users may utilize user terminals to log in the matchmaking system and browse the on-line catalog or menu for selecting an artwork from the digital database. The virtual reality generated by the virtual reality module will be displayed on the display of the user terminal. The users determine whether conduct the transaction depending on the virtual reality present by the virtual reality module. The transaction result will be accordingly displayed on the display of the user terminal.

### BRIEF DESCRIPTION OF DRAWINGS

These and other features, aspects and advantages of invention may be best understood by reference to the following description taken in conjunction with the accompanying drawing in which like numerals represent like elements:

FIG. 1 illustrates a flow chart of the matchmaking method according to the preferred embodiment of the present invention;

FIG. 2 illustrates a block diagram of the matchmaking system according to the preferred embodiment of the present invention;

FIG. 3 illustrates a flow chart for processing the semi-product according to the preferred embodiment of the present invention;

FIG.4 illustrates the disadvantage of the prior art;

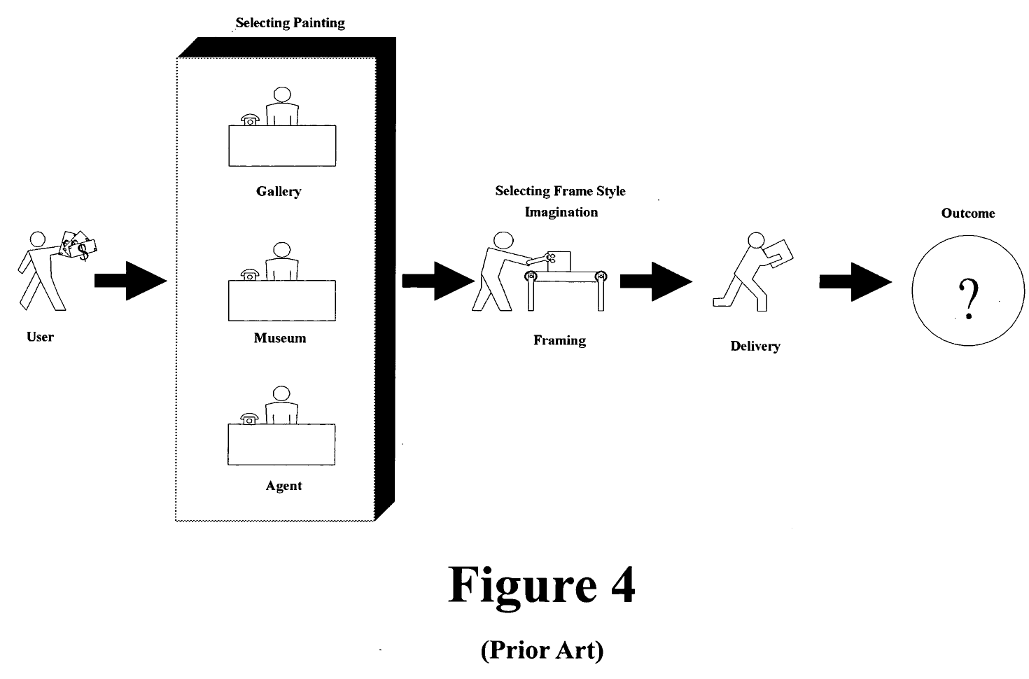

FIG. 5 illustrates another disadvantage of prior art;

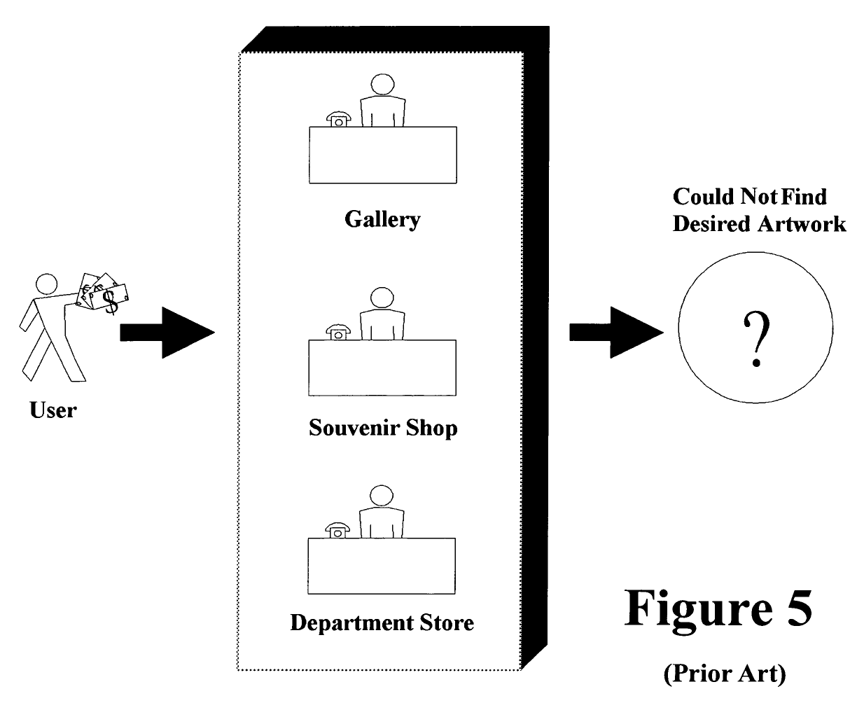

FIG. 6 illustrates exemplary procedures of transaction according to the preferred embodiment of the present invention;

FIG. 7 illustrates an alternative exemplary procedures of transaction according to the preferred embodiment of the present invention; and

FIG. 8 illustrates the effects and advantages of the preferred embodiment.

### DESCRIPTION OF THE PREFERRED EMBODIMENT

In the following description, for the purposes of explanation, numerous specific details are set forth in order to provide a thorough understanding of the present invention. It will be apparent, however, to one skilled in the art that the present invention may be practiced without these specific details. Hence, the preferred embodiment mentioned here is not limited to the details and accompanying claims explicitly described.

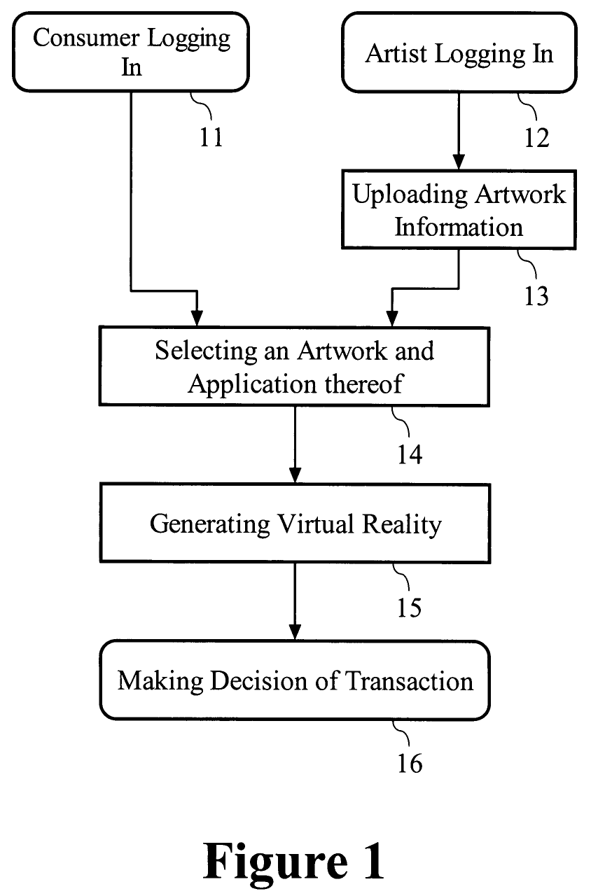

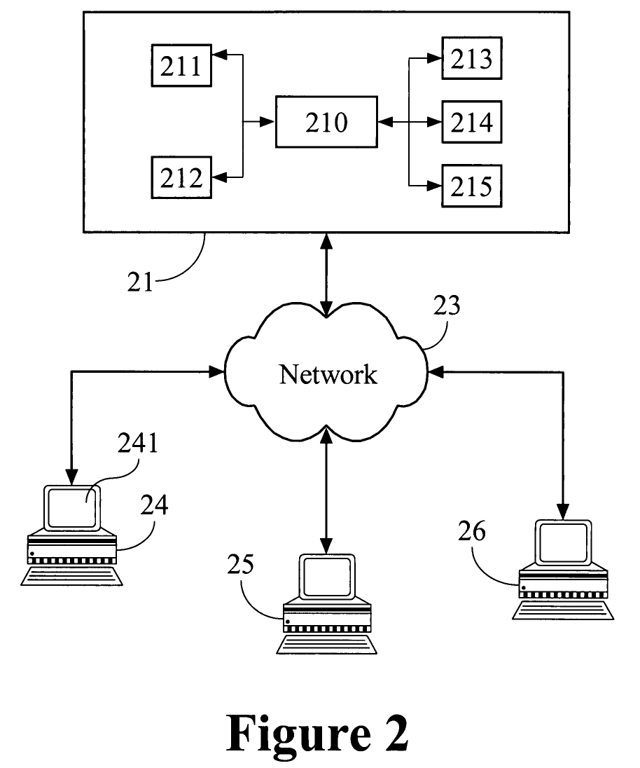

FIG. 1 is a flow chart illustrating a method for facilitating a transaction in accordance with the present invention and FIG. 2 illustrates a system enabling this method.

In step 11, users including common consumers would log in the matchmaking system 21, and the user information is stored in a user database 215 in the system 21. According to the preferred embodiment of the present invention, before a transaction is conducted, users including artists or vendors of the artwork may preload their related information of their artworks onto the matchmaking system 21 by utilizing a user terminal 24 via network 23 in step 12, in order to store the artwork information in a digital database 213, as illustrated in step 13. The user terminals 24-26 may include common computers or various devices capable of network connection, such as a PDA, a smart phone, etc. In the present embodiment, all user terminals and the matchmaking system 21 are coupled to the network 23 as well as communicate or exchange information through the network 23. The digital database 213 may be included in the matchmaking system 21 and coupled to the processor 210. The matchmaking system 21 further comprises a setting database 214 and virtual reality module 211, respectively coupled to the processor 210. The main function of them is to generate a virtual product or virtual reality based on the artwork selected by the users or potential consumers, in order to assist the users determining whether their demands are met. The embodiment of related method will be discussed further below. Moreover, the users herein generally refer to both consumers and artists, or either of them. Every user could utilize the present invention as a consumer and an artist. In other words, the users may freely change their characters depending on their demands.

The artwork information uploaded by the users generally includes the picture or the photograph of the artwork, such the digital image of the artwork (for example, a picture taken by a digital camera or a drawing or slogan made by using graphics software), and authorization information. Such authorization information includes the available application and the price of the uploaded artwork. Besides, the artwork in the present embodiment may comprise a picture, an icon, a photo, a logo, a slogan, and etc. Except the foregoing still data, the digital database 213 could also store the audio or video data.

In step 14, the user or consumer may utilize the user terminal 25 or 26 to connect the matchmaking system 21 through network 23. Generally, the matchmaking system 21 would provide a web interface, and present the related information of the artwork in the digital database 213 and the application options in the setting database 214, in the form of catalog or menu, for the user to browse and choose. In addition, the present also provides various options of application, such as printing the artwork on an object including a cup, clothes, a poster, a towel, a watch, a table lamp, a clock, a gift box, etc. Further, the artwork may be framed, and various frame styles are provided. To achieve such purpose, virtual reality module 211 would generate virtual reality of the selected artwork combined with the selected object or setting (environment) and then present it on a display for users to precisely make decision.

After the artwork and the application thereof are selected by the user, the virtual reality module 211 in the system 21 would generate a virtual reality accordingly, and such virtual reality may be shown in a display of the user terminal (such as the monitor 241 of the user terminal 24), for the user to take as an important reference while determining whether making a transaction, as shown in step 15. In the present embodiment, the virtual reality module may generate a 3D virtual reality which providing various angles of view. Hence, the user could obtain remarkably sufficient and vivid visual information. For instance, a painting is selected to be printed on a gift box, and then the virtual reality module would present the 3D view of the gift box printed with this painting for the user to survey from all angles of view. Alternatively, some photograph may be selected to be framed and hung in the living room (or the kitchen, the bedroom, the office or the store). After the style of the frame is chosen, the virtual reality module would present the 3D virtual reality of the living room with this photograph framed and hung for the user to determine whether her/his demands are met. Except appreciating the virtual reality on-line, the present could also provide associated file(s) of the virtual reality for download, in order to avoid the limit of broadband or be used sometime.

The main advantage of the present invention is the providing of virtual reality. Depending on viewing such virtual reality, the user could appreciate the simulated situation of certain artwork user specific application. Because of the variety and complication of the artwork, one application could not suite with every artwork. In order to avoid regret, the aforementioned mechanism for facilitating the on-line transaction is provided. The user would no longer make transaction purely on personal imagination. Hence, the willing for transaction is highly promoted and the development of the artwork market would be enhanced.

In the preferred embodiment, the virtual reality module 211 is an application installed in the matchmaking system 21. In other words, the virtual reality module 211 is software. However, in other embodiments, the functions of such module could be implemented by hardware or the combination of software and hardware. Since the generation of the virtual reality is well known in the art, related description is omitted to avoid obscuring the present invention. It is emphasized that all suitable techniques of virtual reality may be utilized by the present invention.

After the virtual reality is viewed, the user would make the decision of transaction, as shown in step 16. In the preferred embodiment, the transaction result may be displayed on a display of the user terminal (such as the monitor 241 of the user terminal 24). The matchmaking system 21 is provided with a transaction module 212 for dealing with all procedures after the transaction is made. For example, the user decides to make transaction, and then the transaction module 212 would issue a requisition to the manufacturer for production based on the selection of artwork and application thereof. Finally, the product is sent to the place appointed by the user, and the transaction module 212 would confirm product delivery.

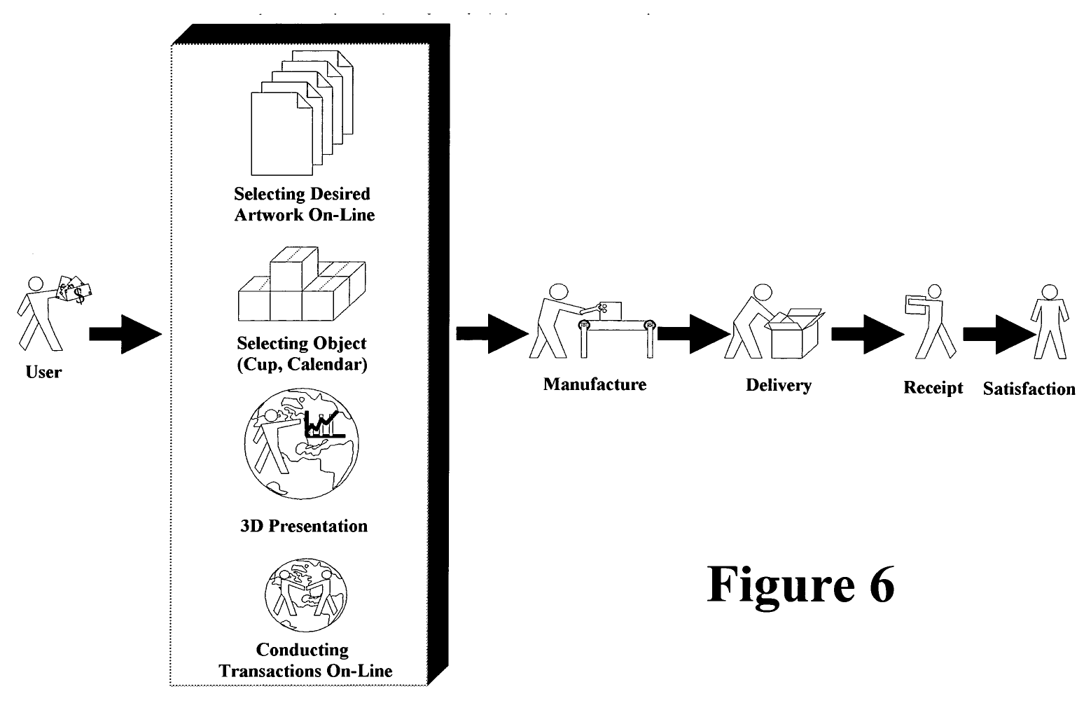

Please refer to FIG. 6, which presents the transaction procedures in accordance of the present invention. In the left side, the consumer (namely the aforementioned user) utilizes the system and method of the present invention to select a painting (artwork) and an object to be printed (application), and appreciates the 3D presentation (virtual reality) to make decision of transaction. After that, the transaction module 212 issues a requisition to the manufacturer for production, and the product would be sent to the user. Since the user has viewed the 3D presentation on-line, the degree of satisfaction would be highly raised.

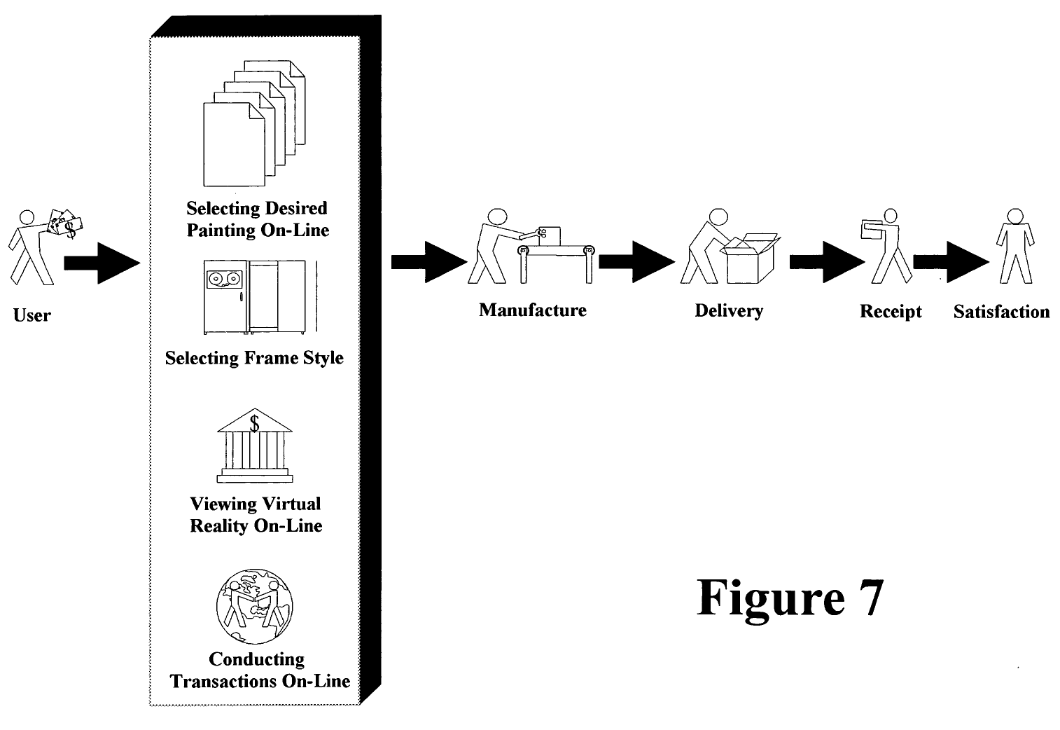

Additionally, please refer to FIG. 7, which presents the transaction procedures of another application. The consumer (user) connects to the matchmaking system through internet to select a painting (artwork) as well as the frame style thereof. Consequently, the consumer views the virtual reality generated by the system and the make decision of transaction accordingly. After the transaction is conducted, the system issues a requisition and delivers the product as mentioned above. Similarly, because of the vivid virtual reality, the gap between the user's expect and reality of the product would be eliminated.

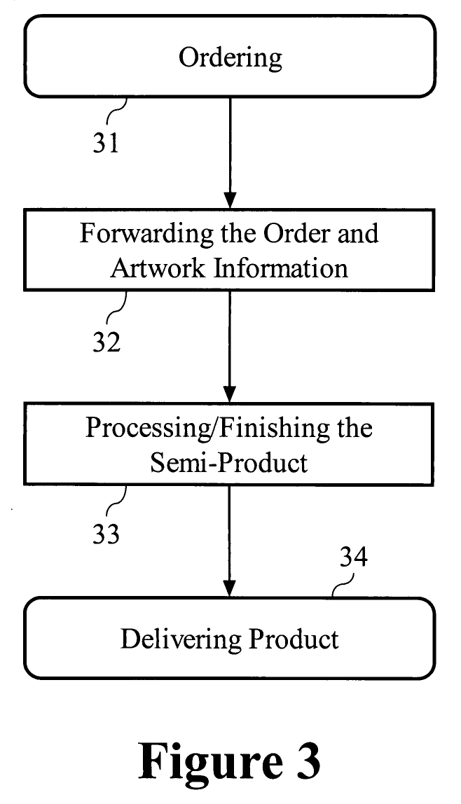

Moreover, please refer to FIG. 3, which presents the procedures for handling the order after the transaction is made, mainly focusing on the processing of semi-product. The present invention provides various applications for the artwork, so huge stock is not necessary. On the other hand, the preparation of flexible semi-product, such as the blank cup, is required. Such blank cup may be easily printed with selected artwork.

In step 31, the user utilizes the matchmaking system of the present invention to order certain products. Such order includes specific artworks and application thereof. The system then forwards this order as well as associated artwork information in the digital database to the manufacturer, as shown in step 32. In step 33, the manufacturer processes or finishes the semi-product based on the user's demands. Finally, the product will be delivered to the user, as shown in step 34. In this way, the huge stock could be avoided and the time to finishing manufacture is shorten for eliminating unexpected risks.

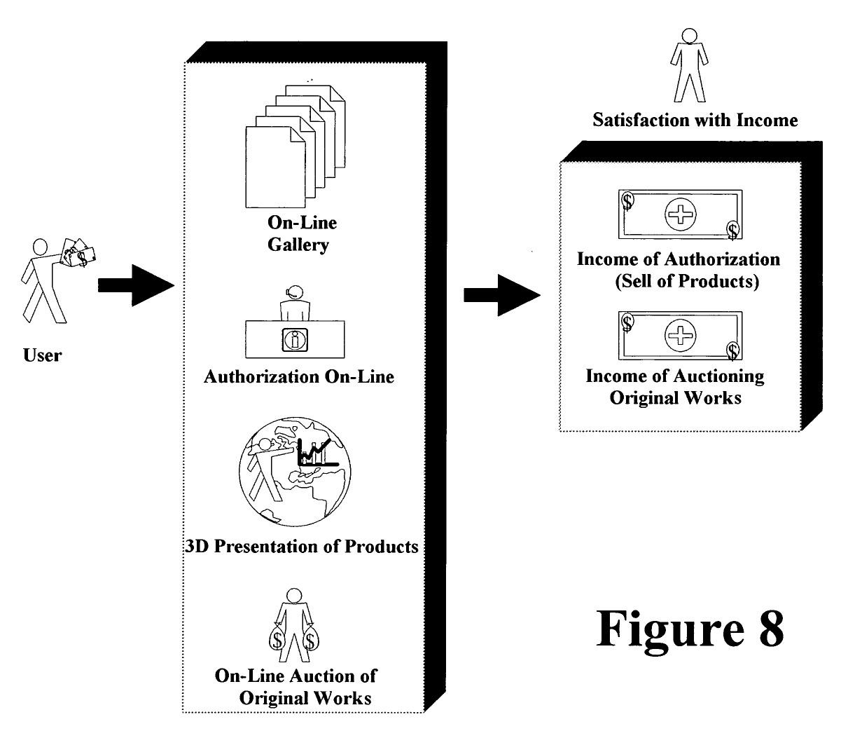

Please refer to FIG. 8, which illustrates the main advantages and effects of the present invention. The user (including the consumer or artist) may utilize the system and method provided by the present invention to conduct transactions, as a consumer or an artist (or a vender of the artwork). The user could browse or make an on-line gallery, and obtain the authorization of a picture or other artworks. Before the transaction is made, the virtual reality of the finished product could be viewed on-line or downloaded for off-line appreciation. Moreover, the user may joint the auction of the original works. In this way, the artist could benefit from the authorization as well as sell or auction the original work. Hence, not only enhancing the quality standard of art, the present invention enriches the socio-economic aspect of the society.

The detailed description of exemplary embodiments of the invention also makes reference to the accompanying drawings, which show the exemplary embodiment by way of illustration and its best mode. While these exemplary embodiments are described in sufficient detail to enable to those skilled in the art to practice the invention, it should be understood that other embodiments may be realized and that logical and mechanical changes may be made without departing from the spirit and scope of the invention.

What is claimed is:

1. A method for matchmaking of an artwork transaction comprising:
logging in a matchmaking system by a user, wherein said matchmaking system includes a digital database, a virtual reality module and a transaction module;
selecting an artwork from said digital database and an application thereof;
presenting a virtual reality under said application generated by said virtual reality module and displaying said virtual reality on a display of user terminal;
determining to conduct a transaction according to said virtual reality by said user;
generating a transaction result by said transaction module and displaying said transaction result on said display of said user terminal.

2. A method according to claim 1, further comprising:
issuing a requisition to a manufacturer for production and confirm product delivery after said transaction.

3. A method according to claim 1, wherein said user utilizes an online catalog to browse and select said artwork from said digital database.

4. A method according to claim 1, wherein plural options of said application are provided by said matchmaking system.

5. A method according to claim 4, wherein said application includes printing said artwork on an object, wherein said object includes a cup, clothes, a calendar, a poster, a towel, a watch, a table lamp, a clock or a gift box.

6. A method according to claim 4, wherein said application includes framing the artwork, and said virtual reality module presents a virtual reality of said artwork framed and hung in a location, wherein said location includes a living room, a kitchen, a bedroom, an office or a store.

7. A method according to claim 6, wherein plural framing styles are provided by said matchmaking system.

8. A method according to claim 1, wherein said artwork includes a picture, an icon, a photo, a logo or a slogan.

9. A system for facilitating said artwork transaction including:
a processor;
a virtual reality module, coupled to said processor; and
a digital database, coupled to said processor, for storing artwork information;
wherein a use logs in said system via Internet, selects an artwork from said digital database, and determines to conduct a transaction according to a virtual reality presented by said virtual reality module.

10. A system according to claim 9, further comprising a setting database for a user to select an application, wherein said virtual reality is generated according to said application.

11. A system according to claim 10, wherein said application includes printing said artwork on an object, wherein said object includes a cup, clothes, a calendar, a poster, a towel, a watch, a table lamp, a clock or a gift box.

12. A system according to claim 10, wherein said application includes framing the artwork, and said virtual reality module presents said virtual reality of said artwork framed and hung in a location, wherein said location includes a living room, a kitchen, a bedroom, an office or a store.

13. A system according to claim 12, wherein plural framing styles are provided by said matchmaking system.

14. A system according to claim 9, further comprising a transaction module, for issuing requisition to manufacturer for production and confirm product delivery.

15. A system according to claim 9, wherein said artwork includes a picture, an icon, a photo, a logo or a slogan.

16. A method for facilitating an artwork transaction comprising:
providing a matchmaking system for a user to log in;
receiving order information of a selected artwork and an application thereof;
processing a semi-product to become a product according to said order information; and
delivering said product to said user.

17. A method according to claim 16, wherein said application includes printing said artwork on an object, wherein said object includes a cup, clothes, a calendar, a poster, a towel, a watch, a table lamp, a clock or a gift box.

18. A method according to claim 16, wherein said application includes framing the artwork.

19. A method according to claim 16, wherein said artwork includes a picture, an icon, a photo, a logo or a slogan.
